(19) United States
(12) Patent Application Publication
(10) Pub. No.: US 2014/0156658 A1
(43) Pub. Date: Jun. 5, 2014

(54) ELECTRONIC DEVICE AND METHOD FOR DISPLAYING EXAMINATION PROCESS

(71) Applicants: Chung-I Lee, New Taipei (TW); Hai-Hong Lin, Shenzhen (CN); De-Yi Xie, Shenzhen (CN); Shuai-Jun Tao, Shenzhen (CN); Zhi-Qiang Yi, Shenzhen (CN); Jun-Chao Yao, Shenzhen (CN)

(72) Inventors: Chung-I Lee, New Taipei (TW); Hai-Hong Lin, Shenzhen (CN); De-Yi Xie, Shenzhen (CN); Shuai-Jun Tao, Shenzhen (CN); Zhi-Qiang Yi, Shenzhen (CN); Jun-Chao Yao, Shenzhen (CN)

(21) Appl. No.: 13/808,247

(22) PCT Filed: Jul. 13, 2012
(86) PCT No.: PCT/CN12/78626

§ 371 Date: Jan. 3, 2013

(30) Foreign Application Priority Data
Apr. 2, 2012 (CN) 201210096199.3

(51) Int. Cl. G06F 17/30

(52) U.S. Cl. CPC G06F 17/30011
USPC 707/736

(57) ABSTRACT

In a method for displaying an examination process of a patent application, one or more examination files of the patent application are obtained. The method obtains contents of each examination file, determines one or more rejected claims in each examination file by analyzing the contents of each examination file, and creates rejection information corresponding to each rejected claim. The method further creates a node for each examination file according to a preset mode, displays the rejection information of the rejected claims in a specific examination file on a display device when a node of the specific examination file is selected.

### BACKGROUND

1. Technical Field

Embodiments of the present disclosure relate to data analyzing technology, and particularly to an electronic device and method for displaying examination process of a patent application using the electronic device.

2. Description of Related Art

Increasingly, many companies, colleges, and other organizations, are submitting patent applications to patent offices (e.g., USPTO). For someone to obtain information of a specific patent application, he or she may need to get copies of all the examination files (e.g., first Office action and final Office action). This person must then read each examination file one by one to find out rejected claims of the specific patent application and find out corresponding rejection law (e.g., 35 U.S.C. 103(a)) and cited prior art. This is a time-consuming endeavor. Therefore, there is a need for improvement in the art.

### BRIEF DESCRIPTION OF THE DRAWINGS

FIG. 1 is a block diagram of one embodiment of an electronic device including an examination process display system.

FIG. 2 is a schematic diagram of function modules of the examination process display system included in the electronic device.

FIG. 3 is a flowchart of one embodiment of a method for displaying an examination process of a patent application using the electronic device.

FIG. 4 is an exemplary schematic diagram of a plurality of nodes corresponding to examination files of the patent application.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other storage medium.

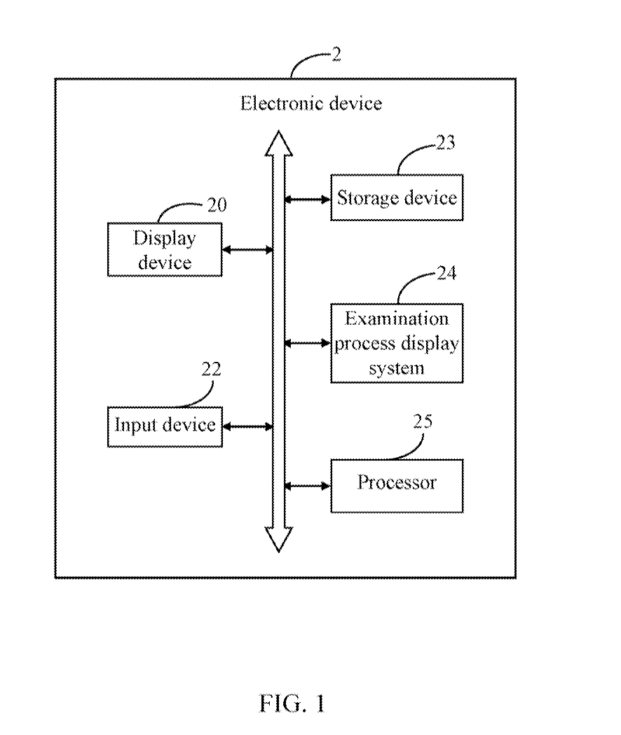

FIG. 1 is a block diagram of one embodiment of an electronic device 2 including an examination process display system 24. In the embodiment, the electronic device 2 further includes a display device 20, an input device 22, a storage device 23, and at least one processor 25. The electronic device 2 may be a computer, a smart phone or a personal digital assistant (PDA). It should be understood that FIG. 1 illustrates only one example of the electronic device 2 that may include more or fewer components than illustrated, or have a different configuration of the various components in other embodiments.

The display device 20 may be used to display rejection information (e.g., rejected claims and rejection law) of a patent application, and the input device 22 may be a mouse or a keyboard used to input computer readable data. The storage device 23 may be a non-volatile computer storage chip that can be electrically erased and reprogrammed, such as a hard disk or a flash memory card.

The examination process display system 24 is used to extract the rejection information of the patent application from one or more examination files of the patent application, and display the rejection information on the display device 20 according to a preset mode. In one embodiment, the examination process display system 24 may include computerized instructions in the form of one or more programs that are executed by the at least one processor 25 and stored in the storage device 23 (or memory). A detailed description of the examination process display system 24 will be given in the following paragraphs.

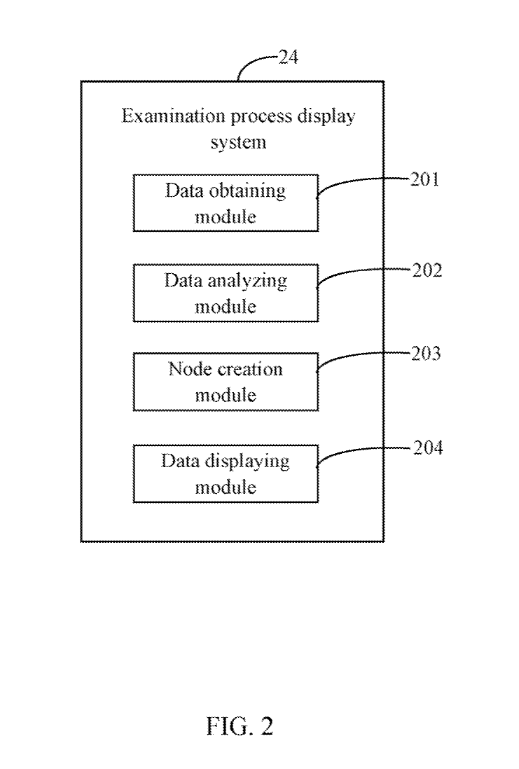

FIG. 2 is a block diagram of function modules of the examination process display system 24 included in the electronic device 2. In one embodiment, the examination process display system 24 may include one or more modules, for example, a data obtaining module 201, a data analyzing module 202, a node creation module 203, and a data displaying module 204. In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include flash memory and hard disk drives.

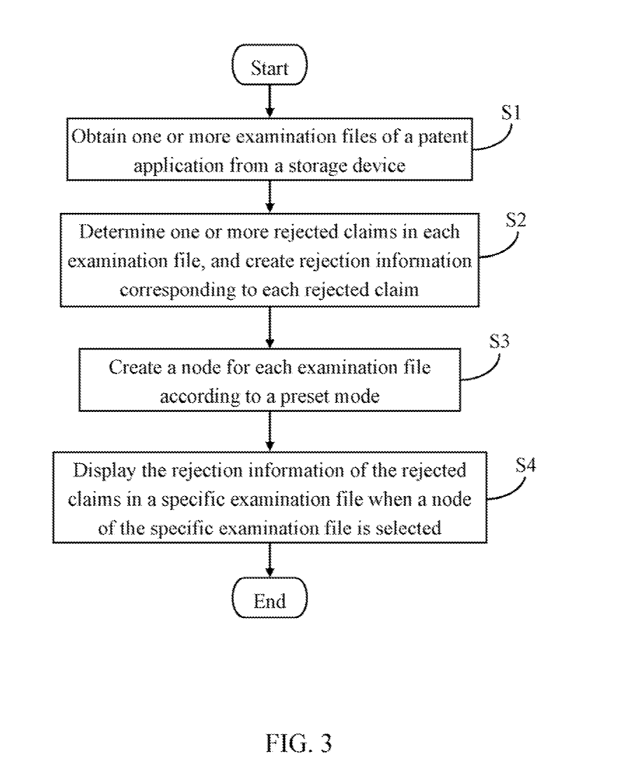

FIG. 3 is a flowchart of one embodiment of a method for displaying an examination process of a patent application using the electronic device 2. Depending on the embodiment, additional steps may be added, others removed, and the ordering of the steps may be changed.

In step S1, the data obtaining module 201 obtains one or more examination files of a patent application from the storage device 23, and extracts textual contents (or informational contents) of each examination file. For example, the examination files include a first Office action, a second Office action, a final Office action, and so on. The data obtaining module 201 extracts the textual contents of each examination file by recognizing each character in each examination file using an optical character recognition method. The examination files are pre-stored in the storage device 23. In some embodiments, the textual contents are the detailed descriptions (i.e., full text) of the examination file.

In step S2, the data analyzing module 202 determines one or more rejected claims in each examination file by analyzing the textual contents of each examination file, and creates rejection information corresponding to each rejected claim. In one embodiment, the rejection information may include, but is not limited to, the rejected claims in each examination file, and rejection law and prior art (one or more references) corresponding to each rejected claim cited on the examination file. In other embodiments, the rejection information may further include a name and a telephone number of the Examiner of the patent application. A detailed description of step S2 is as follows.

The data analyzing module 202 determines a main part of each examination file by analyzing the textual contents of each examination file according to a character matching method and preset key words. In one embodiment, the character matching method may be a regular expression matching method. For example, if the patent application is filed to USPTO, the preset key words include “Detailed Action” and “Notice of References Cited Application”, then the textual contents between “Detailed Action” and “Notice of References Cited Application” is determined as the main part of each examination file.

The data analyzing module 202 determines specific objection characters in the main part of each examination file. In one embodiment, the objection characters is used as an indicator to represent that specific claims are objected to by the Examiner. For example, if the patent application is a US application, the Examiner may describe the rejection opinion as follows: “Claims 2, 3, 15 and 16 are rejected under 35 U.S.C. 103(a) as being unpatentable over reference A (US 2008/______)”, thus, the characters of “rejected under” are determined to be the specific objection characters.

The data analyzing module 202 determines first claims in a front part of the specific objection characters of each examination file according to a first matching string (e.g., a first regular expression), the first claims in the front part of the specific objection characters are determined as the rejected claims in each examination file. In one embodiment, the first claims in the front part of the specific objection characters are the nearest claims in front of the specific objection characters of each examination file. In the above-mentioned example, claims 2, 3, 15 and 16 are the nearest claims in front of the specific objection characters “rejected under”. The front part of the specific objection characters is determined as a first preset range before the specific objection characters, for example, the front part fifty characters before the specific objection characters.

In one embodiment, the first regular expression may be obtained by analyzing a description format of the claims in the main part of each examination file. For example, if the patent application is the US application, the description format of the claims may be as follows: “Claims 2, 3, 15 and 16”, thus, the first regular expression may be determined as “Claims?\s*\d.*”.

The data analyzing module 202 determines first rejection law in a latter part of the specific objection characters of each examination file according to a second matching string (e.g., a second regular expression), the first rejection law are determined as the rejection law corresponding to the rejected claims. In one embodiment, the first rejection law in the latter part of the specific objection characters are the nearest rejection law in the latter part of the specific objection characters of each examination file. In the above-mentioned example, “35 U.S.C. 103(a)” is the nearest rejection law in latter of the specific objection characters “rejected under”. The latter part of the specific objection characters is determined as a second preset range after the specific objection characters, for example, the latter part seventy characters after the specific objection characters.

In one embodiment, the second regular expression may be obtained by analyzing a description format of the rejection law in the main part of each examination file. For example, when the patent application is a US application, the description format of the rejection law may be as follows: “35 U.S.C. 103(a)”, thus, the second regular expression in the present application may be determined as “\d{2}\s*USC\s*§\s*\d{3}\s*(\(\s*\w\s*\))?\s*-?\s*(\(\s*\w\s*\))?|\d{2}\s*U.S.C.\s*\d{3}\s*(\(\s*\w\s*\))?\s*-?\s*(\(\s*\w\s*\))?|\d{2}\s*CFR\s*[\d.]{3,}\s*(\(\s*\w\s*\))?\s*-?\s*(\(\s*\w\s*\))?”.

The data analyzing module 202 determines first prior art in the latter part of the specific objection characters of each examination file according to a third matching string (e.g., a third regular expression), the first prior art are determined as the prior art corresponding to the rejected claims cited on each examination file. In one embodiment, the first prior art in the latter part of the specific objection characters are the nearest prior art in the latter part of the specific objection characters of each examination file. In the above-mentioned example, “reference A (US 2008/______)” is the nearest prior art in the latter part of the specific objection characters “rejected under”. The latter part of the specific objection characters is determined as the second preset range after the specific objection characters. In other embodiments, the latter part of the specific objection characters which is used to determine the first prior art may be determined as a third preset range after the specific objection characters, for example, the latter part ninety characters after the specific objection characters.

In one embodiment, the third regular expression may be obtained by analyzing a description format of the prior art in the main part of each examination file. For example, the description format of the prior art may be as follows: “US 2009/______”. Then, the second regular expression may be determined as “(PCTV)?(U\.?[S5]\.?\s*|K\.?R\.?\s*|T\.?W\.?\s*|E\.?P\.?\s*|C\.?N\.?\s*|J\.?P\.?\s*|Science\.?\s*)?(P[GAU][PTB]\w*\.?\s*)?(NO\.?\s*:?\s*|Application\s*)?(Publication\s*)?(NO\. ?\s*:?\s*)?\d[̂a-zA-Z]{3,13}\d{2}(\s*\)?\{0,2}\d?\s*)?”.

The data analyzing module 202 creates a relationship among the rejected claims, the rejection law, and the prior art. For example, the relationship may be described as follows: “claim 1 is rejected under the rejection law “35 U.S.C. 103(a)” over the prior art US 2009/______”.

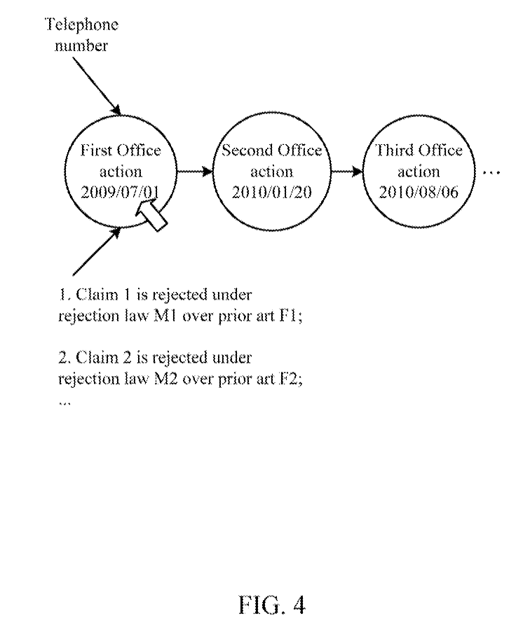

In step S3, the node creation module 203 creates a node for each examination file according to a preset mode. The node of each examination file includes the rejected claims and corresponding rejection information in the examination file. As shown in FIG. 4, the preset mode may be a time sequence of each examination file of the patent application.

In step S4, the data displaying module 204 displays the rejection information of the rejected claims in a specific examination file on the display device 20 when a node of the specific examination file is selected. The rejection information may include the rejected claims in the specific examination file, the rejection law and the prior art corresponding to each rejected claim, and the telephone number of the Examiner. For example, as shown in FIG. 4, when a cursor is positioned on the first node, the rejection information of the first Office action is displayed on the display on the display device 20.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for displaying an examination process of a patent application using an electronic device, the method comprising:
obtaining one or more examination files of the patent application from a storage device of the electronic device, and obtaining contents of each of the examination files;
determining one or more rejected claims in each of the examination files by analyzing the contents of each of the examination files, and creating rejection information corresponding to each of the rejected claims;
creating a node for each of the examination files according to a preset mode; and
displaying the rejection information of the one or more rejected claims in a specific examination file on a display device of the electronic device upon the condition that a node of the specific examination file is selected.

2. The method according to claim 1, wherein the rejection information comprises the rejected claims in each of the examination files, and rejection law and prior art corresponding to each of the rejected claims cited on the examination files.

3. The method according to claim 1, wherein the rejection information are created by:
determining a main part of each of the examination files by analyzing the contents of each of the examination files according to a character matching method and preset key words;
determining specific objection characters in the main part of each of the examination files;
determining rejected claims in a front part of the specific objection characters of each of the examination files according to a first matching string;
determining rejection law in a latter part of the specific objection characters of each of the examination files according to a second matching string;
determines prior art in the latter part of the specific objection characters of each of the examination files according to a third matching string; and
creating a relationship among the rejected claims, the rejection law, and the prior art.

4. The method according to claim 3, wherein the front part of the specific objection characters is a first preset range before the specific objection characters.

5. The method according to claim 3, wherein the latter part of the specific objection characters is a second preset range after the specific objection characters.

6. The method according to claim 3, wherein the character matching method is a regular expression matching method.

7. An electronic device, comprising:
a storage device;
at least one processor; and
one or more modules that are stored in the storage device and are executed by the at least one processor, the one or more modules comprising:
a data obtaining module that obtains one or more examination files of a patent application from the storage device, and obtains contents of each of the examination files;
a data analyzing module that determines one or more rejected claims in each of the examination files by analyzing the contents of each of the examination files, and creates rejection information corresponding to each of the rejected claims;
a node creation module that creates a node for each of the examination files according to a preset mode; and
a data displaying module that displays the rejection information of the one or more rejected claims in a specific examination file on a display device of the electronic device upon the condition that a node of the specific examination file is selected.

8. The electronic device according to claim 7, wherein the rejection information comprises the rejected claims in each of the examination files, and rejection law and prior art corresponding to each of the rejected claims cited on the examination files.

9. The electronic device according to claim 7, wherein the data analyzing module creates rejection information by:
determining a main part of each of the examination files by analyzing the contents of each of the examination files according to a character matching method and preset key words;
determining specific objection characters in the main part of each of the examination files;
determining rejected claims in a front part of the specific objection characters of each of the examination files according to a first matching string;
determining rejection law in a latter part of the specific objection characters of each of the examination files according to a second matching string;
determining prior art in the latter part of the specific objection characters of each of the examination files according to a third matching string; and
creating a relationship among the rejected claims, the rejection law, and the prior art.

10. The electronic device according to claim 9, wherein the front part of the specific objection characters is a first preset range before the specific objection characters.

11. The electronic device according to claim 9, wherein the latter part of the specific objection characters is a second preset range after the specific objection characters.

12. The electronic device according to claim 9, wherein the character matching method is a regular expression matching method.

13. A non-transitory storage medium having stored thereon instructions that, when executed by a processor of an electronic device, causes the electronic device to perform a method for displaying an examination process of a patent application, the method comprising:
obtaining one or more examination files of the patent application from a storage device of the electronic device, and obtaining contents of each of the examination files;
determining one or more rejected claims in each of the examination files by analyzing the contents of each of the examination files, and creating rejection information corresponding to each of the rejected claims;
creating a node for each of the examination files according to a preset mode; and
displaying the rejection information of the one or more rejected claims in a specific examination file on a display device of the electronic device upon the condition that a node of the specific examination file is selected.

14. The non-transitory storage medium according to claim 13, wherein the rejection information comprises the rejected claims in each of the examination files, and rejection law and prior art corresponding to each of the rejected claims cited on the examination files.

15. The non-transitory storage medium according to claim 13, wherein the rejection information are created by:
determining a main part of each of the examination files by analyzing the contents of each of the examination files according to a character matching method and preset key words;
determining specific objection characters in the main part of each of the examination files;
determining rejected claims in a front part of the specific objection characters of each of the examination files according to a first matching string;
determining rejection law in a latter part of the specific objection characters of each of the examination files according to a second matching string;
determines prior art in the latter part of the specific objection characters of each of the examination files according to a third matching string; and
creating a relationship among the rejected claims, the rejection law, and the prior art.

16. The non-transitory storage medium according to claim 15, wherein the front part of the specific objection characters is a first preset range before the specific objection characters.

17. The non-transitory storage medium according to claim 15, wherein the latter part of the specific objection characters is a second preset range after the specific objection characters.

18. The non-transitory storage medium according to claim 15, wherein the character matching method is a regular expression matching method.
